(19) United States
(12) Patent Application Publication
(10) Pub. No.: US 2009/0043616 A1
(43) Pub. Date: Feb. 12, 2009

(54) SYSTEM AND METHOD FOR THE INTERNET EXCHANGE OF GOLF COURSE TEE TIMES

(76) Inventor: Alberto Vargas Chavez, Zapopan (MX)

Correspondence Address: MARC E. HANKIN, ESQ., 11414 THURSTON CIRCLE, LOS ANGELES, CA, 90049, US

(21) Appl. No.: 12/182,091

(22) Filed: Jul. 29, 2008

(30) Foreign Application Priority Data
Jan. 30, 2006 (MX) PCT/MX2006/000006

(51) Int. Cl. G06Q 10/00

(52) U.S. Cl. 705/5

(57) ABSTRACT

The invention relates to a system and method for the Internet exchange of golf course tee times. According to the invention, system-affiliated golfers with one or more golf course tee times can offer said tee times online on the Internet when, instead of using his/her tee times, the user wishes to hand a tee time over for exchange such that it can be taken by other users of the exchange system. The system users can open as many options as necessary in order to take tee times deposited by other users in the exchange system in accordance with the tee times that he/she has previously handed over, i.e., the user can take one tee time for each tee time that he/she has previously deposited for exchange.

### RELATED APPLICATIONS

This application claims the benefit of international application no. PCT/MX2006/000006 filed Jan. 30, 2006 by the present inventor.

### FIELD OF INVENTION

The present invention relates generally to computer systems to provide members of golf clubs online services. More specifically, it relates to a system and method for the internet exchange of use rights for golf course tee times.

### BACKGROUND

Canadian Patent No. 2,325,586, issued to Avalanche Networks Corp., describes an online system offering last-minute use rights for tee time reservations (known as “tee off time”) for users of public golf courses. The proposed system consists of a website enabled with a server connected to a network. The site includes: a database of use rights available, within the following 24 hours, in a plurality of public golf courses, including information on each golf course and on the use rights available; a means of data entry to allow entry of information of the use rights in the registries of the database (information that can be risky does not have a safe form to validate it); an implementation means that allows the promotion of use rights during a predetermined time, varying costs according to the proximity of the tee time and the golf course; and a means to allow the use rights that are promoted to be seen and reserved by a potential consumer using a computer connected to the network.

Being that the system of Avalanche's patent handles reservations of use rights supplied at the last moment (because they are cancelled tee times), clearly this system is limited. It does not pertain to golfers who do not belong to a golf club and or who do not live within an area or geographic region near a golf course which promotes itself for such last-minute reservations. On the contrary, the new exchanges system, apart from its main purpose in promoting exchanges between members of affiliated golf clubs, allows the handling (supply and reservations) of use rights in much more flexible periods of time. This makes it possible for an interested member, who is traveling for whatever reason, to have the opportunity to program and exchange his use rights to practice his favorite sport in a golf course far removed from his place of origin.

Japanese Patent No. 2001155104, issued to Taniguchi Yasumichi, refers to a method and system for Internet registration of use rights for golf courses similar to the Canadian patent. This method is conceived for public golf courses to maximize their one day sales. Also, a person who wishes to play golf can make a reservation of use rights under a specified condition. The method allows the golf course to acquire data of people who wish to play golf. In this way, the system has the opportunity itself to collect many clients, even though it suffers a discount in the case of many unreserved places in tee-off time reservations. Yasumichi proposes that the golfer looking for a tee time ask for a “wished condition”, that is to say, a cancellation of a tee time, using the home page on the Internet of a site opened by a company or individual that offers the service of reservation of use rights. By means of this system, the person who wants to play golf uses the Internet to acquire this reservation when the “wished condition” agrees with the supplied one by the golf course and then it confirms the reservation of use rights via the Internet.

On the other hand, Taniguchi seems to be focused mainly on sale of reservations of cancelled use rights for any golfer interested in playing golf. This purely commercial approach is far from the new exchanges system that will be described here, because the Taniguchi system is not conceived for the promotion of exchanges of use rights of members of golf clubs previously adhered to a reciprocity agreement. As it is observed ahead the new exchanges system contributes a rich collection of benefits that are not had with the traditional systems nor previously mentioned.

As it can be observed, the patents described are clearly focused on the sale of cancelled use rights from public golf courses, which demonstrates an operative difference between the previous patents and the current invention. Therefore, none of the previously referenced patents offers an accessible and convenient exchange system implemented especially for online exchanges of use rights for members of affiliated golf courses. An advantage of the new system is, for example, the exchange of use rights by paying a very low quota in comparison with the costs of either paying with reservations done by means of the traditional system or systems before referred. Also, the system promotes the exchange of use rights for the benefit of golfers of affiliated golf clubs or golf courses who travel for pleasure or business to another city or country and who would like to play in a golf course different from their city of origin's own golf course, without needing to pay for that reason beyond a minimum quota by exchange of use rights, no matter the golf course elected.

### SUMMARY OF THE INVENTION

It is an object of the present invention to propose a system and method designed to provide exchanges of use rights of golf courses (tee times), using the Internet. The system gives golfers from any part of the world the opportunity to exchange use rights with other golfers of other affiliated golf clubs to the exchanges system, and to be able to play in different golf course from their own, paying in some cases only one small amount or minimum quota.

Another object of the invention is to provide to interested golfers the opportunity to visit different golf courses without needing the express invitation of some member, as it is custom, and to allow him to continue playing his favorite sport in conditions similar to those of his golf club of origin, when the golfer travels outside his area of residence for pleasure or business.

Another object of the present invention is to propose an Internet exchanges system for golfers by means of which those with affiliated golf clubs with one or several use rights of a golf course may exchange tee times instead of abandoning their use rights, opening many options to take from the System of deposited right Exchanges like the ceded rights (1×1). As an example, a member of a golf club has the right to play every day of the week that the golf club remains in service. Possibly the member can only use three days, then he can ask for his golf club to deposit the remaining days to the exchanges system. If the golf club accepts, they are stored in the worldwide database of exchanges and are immediately available so that any other affiliate to the exchanges system can take them.

### BRIEF DESCRIPTION OF THE DRAWINGS

FIG. 1 is a schematic view of the invention that shows the online exchange system of use rights for golf courses.

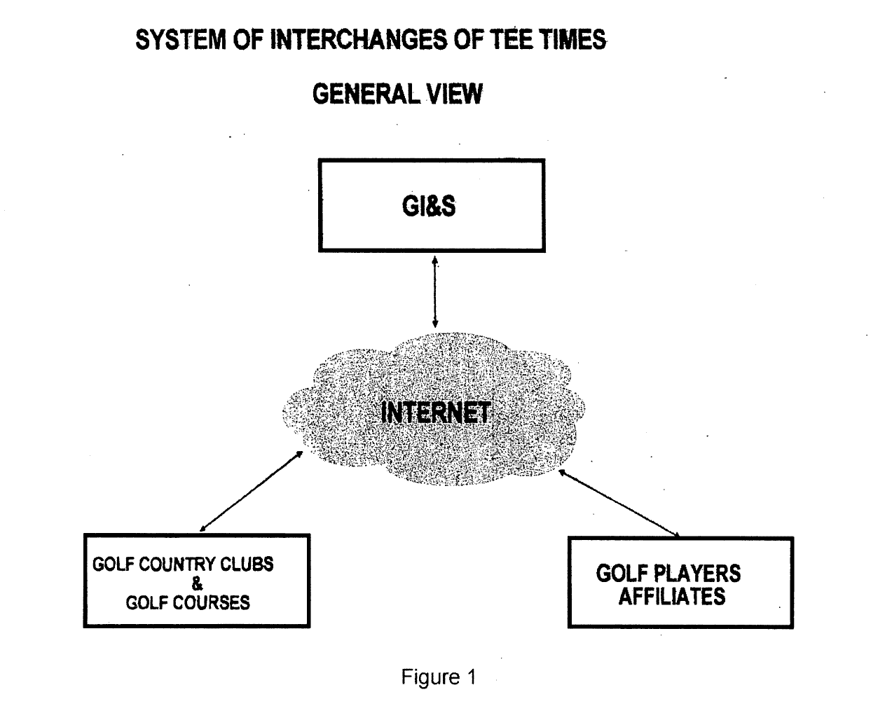

FIG. 2 is a block diagram that illustrates the methodology of the system to carry out exchanges of golf course use rights.

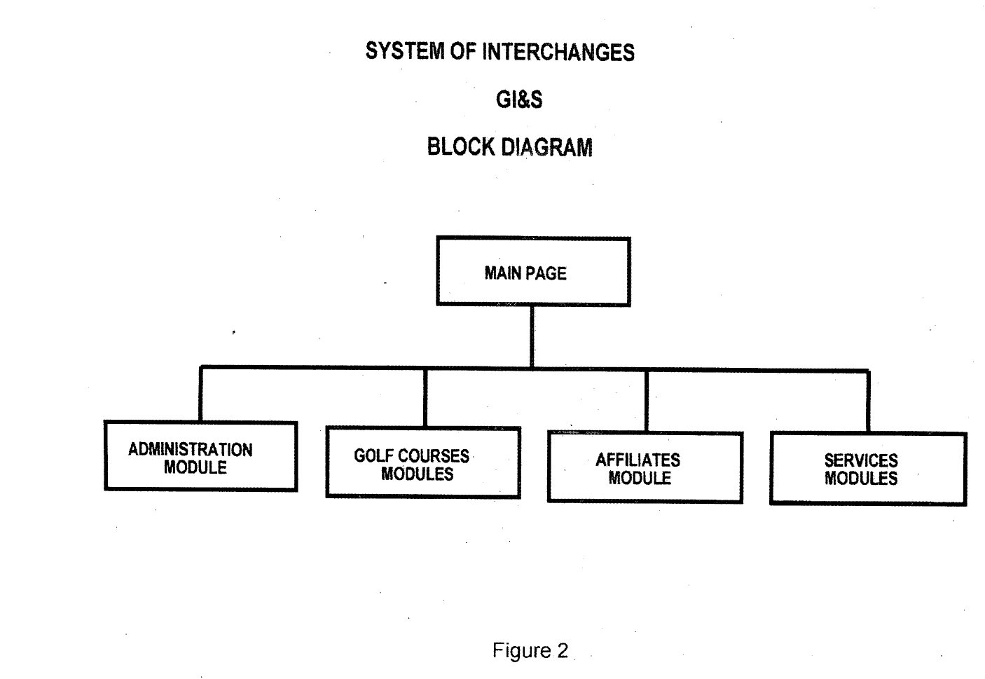

FIG. 3 is a schematic drawing of the main modules of the system that constitute the new exchange system.

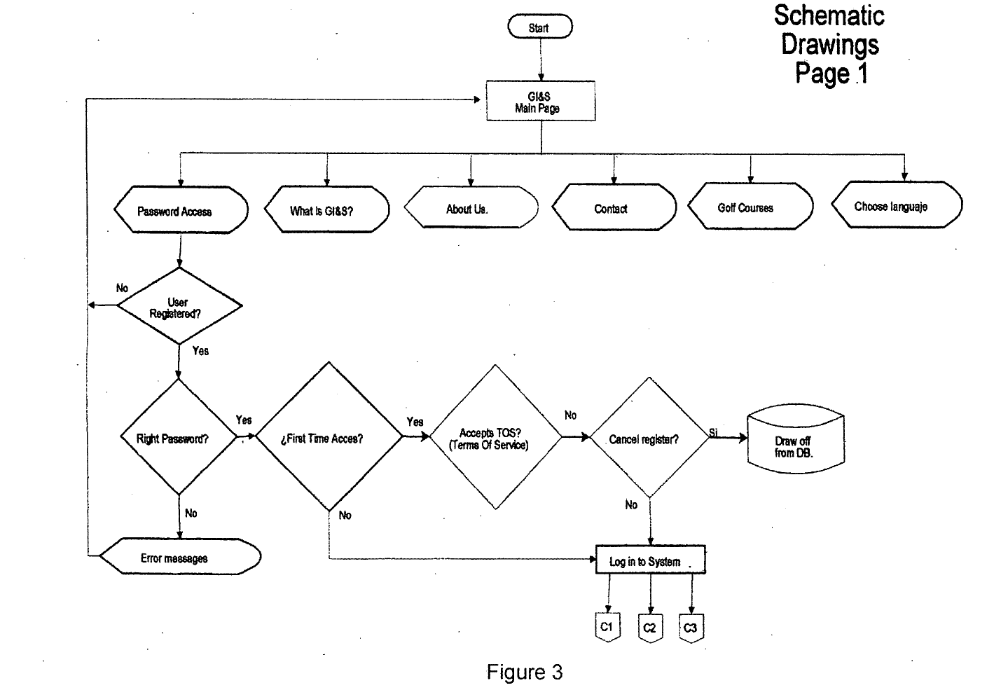

### DETAILED DESCRIPTION OF THE DRAWINGS

The online exchange system of use rights for golf courses consists of a website linked to a central computer (server) connected to a computer network (in this case the Internet), databases and an information system based on applications for networked computer, where the interaction of the members of different golf clubs is allowed for exchanges of use rights (commonly known as tee times) between the affiliates and the different golf clubs to which they belong. This exchanges system gives the golf clubs the opportunity to classify themselves (as private, semi-private, resort, military, public) to select its class of golf clubs, as well to make exchanges. In order to initiate the activation and handling of the system, the golf clubs interested in offering their members the opportunity to play in other golf courses in a safe way and at a minimum cost will adhere to this system, signing a contract of participation with Golf Interchanges & Services (“GI&S”), by means of which they will be committed to serve the affiliates of the GI&S system, as if one was their own member.

In one preferred embodiment, the exchanges system will be available only for golfers whose golf clubs or golf courses have previously signed the contract of adhesion to the exchanges system. However, this should not be interpreted as limiting the potential scope of the application because it is an option for all golfers interested in using the advantages of the system. Another embodiment, if it were necessary, could have some open concepts so that the intention conceived is fulfilled originally at a low cost to promote the exchange of use rights between golfers.

The system is based mainly on a website on the Internet that will be connected to a main computer (Server) that will store functions and administer the access of other remote computers (Clients), golf clubs, members or general public through software previously designed to carry out, with the necessary security, the management of the exchanges of use rights suitably as ahead it is detailed.

Technically, the system consists of one or several main computers (Server) connected in network (wire, wirelessly or the Internet preferably) containing the databases and the programs that give rise and foundation to the system that is described here, servers, and remote computers (Clients) that are used by the users to the described system, using any type of Internet accessible connection that the user has. These computer programs generate the interaction between the servers, the databases, the golf clubs and golf courses and the affiliates, through the network of computers, in order to facilitate the safe exchange of use rights of golf courses.

Operatively, it is an exchanges system via the Internet of use rights for golf courses conceived for members of golf clubs, and golfers, in which several days can be registered for players that want to exchange one or more (1 round of golf of 18 holes per day). The interested players registered in the system are put in the database of the servers so that other affiliates enrolled in the system can visualize the use rights supplied and take the use rights (rounds of game of 18 holes) in exchange for rights they had deposited previously in the system. This system was developed with the main purpose of covering the great emptiness that has prevailed in the traditional culture of this sport, changing the ancestral paradigm of the privacy of the golf courses, and modernizing this paradigm to a globalized world, where the dynamism of the change is breaking cultural barriers. It offers opportunities to us to obtain better standards of life, using the technology of the information, being useful the modern tools communications, as it is in the case of computation and the Internet.

Generally, the fundamental parts of this system are the golf clubs, the members of the same and the exchanges system (GI&S), which is a compound of the following subsystems:
1.—MODULE OF SYSTEM MANAGEMENT GI&S
2.—MODULE OF GOLF CLUBS
3.—MODULE OF AFFILIATES
4.—MODULE OF SERVICES
5.—MODULE OF INFORMATION AND AID

The module of system management GI&S is composed of computer programs necessary to guarantee the perfect operation of the exchanges system, to assure confidentiality of the data contributed by the participants, as well as the correct application of its services demands offered by the system, and to obtain what is required to maintain (sign up, modifications, unsubscribe) the general parameters of the system, interphases with banks and forms of collections, motors search, utilities, anti-virus, anti-spyware, anti-hackers, report, registry of golf clubs, agreements, regulations, e-mail and general services of aid and benefits to users, among others.

Administrators of the System. This part of the system is not accessible to the affiliated golf clubs or golf players; it is exclusively for the administrators of the system and is only for the purpose of maintaining and conserving the security, operability and integrity of the information that the Exchanges system handles, as well as for the confidentiality of the data of the affiliates, like of the golf clubs or golf courses.

Privileges of Administrators. In the same manner as the above paragraph, privileges are exclusive to administrators to allow access to certain levels of the system data and, depending on who is assigned access to privileges, they will have access to the medullar parts of the system in order to preserve the correct operation of the same.

Golf Clubs and Golf Courses (Discharges, Changes, Losses)

Pre-Registration. Golf clubs and golf courses interested in affiliating themselves with the Exchanges system do so in a virtual form that does not constitute a direct affiliation. A direct affiliation is obtained by having the contract properly signed by the legal representatives of the golf club and GI&S.

Registration in the GI&S system. Once the contract is signed by the legal representative, the golf club is registered in the system.

Modification of data. Provided so that, if for some reason, it is necessary to make some modification to golf club data.

Unsubscribing from the GI&S system. Provided for when a golf course or golf club asks for unsubscribing, or violates the agreements.

Incorporation of Golf Courses. A golf club and a golf course are defined separately because some golf clubs have more than one golf course. The initial data of the golf course is registered, i.e.: direction, telephone numbers, city, number of holes, and classification of the golf course (private, semi-private, resort, military and public, among others). In the same way, the golf club chooses the type of affiliates it accepts in exchange, in agreement with the classification of the golf club of origin of the affiliate. For example, a private golf club chooses exchanges with affiliates coming from private and semi-private golf courses. Then, affiliates coming from public golf courses, resorts and others, will not have access to the use rights deposited by the members of this golf course. Similarly, the golf club chooses if it accepts groups and if so, in which player amounts (2, 3 or 4) in the golf jargon (twosome, threesome, foursome).

Additionally, the golf club announces its internal rules and basic norms so that the affiliates to the Exchanges System know them before carrying out any exchange. Also in this module, the golf club informs the affiliates of the services, rights, restrictions and discounts obtained for affiliates of GI&S, with or without needing to mediate some exchange, as well as discounts and facilities in the use of the premises and services that the same golf club grants to its members and whether the affiliate has those rights.

Operation. This is the administrative area that has personal communication with managers of the golf clubs, and is where the exchanges system is promoted, in the same manner, for those looking for more and better additional benefits for the affiliates to this system.

Members. Reception of preregistered golf club members interested in participating in the GI&S Exchanges system, and pursuit to these requests of participation.

Legal. The area that is in charge to validate and to assure that the agreements conducted with golf clubs and members, and other benefits negotiated with third parties, are respected in favor of all the participants of this Exchanges system.

Payments (discharges, changes, losses). This module, like others, has the purpose to facilitate the modes of payment more suited to affiliates in their interaction with the system and to explain the same.

Administration E-mails. Because this it is a semiautomatic system interacting through the WEB or the Internet, the communication in its great majority between the participants, is through electronic mail, and the interaction of affiliates, golf courses and golf clubs is defined by agreements established with the same. A high content of the information that is received via email is directed automatically to areas of the system that will take the received information and apply it to the module to which it corresponds, and other information will be directed so that it is taken care of by described personnel.

Automatic responses. For the information received via electronic mail or the information generated by the interaction of the modules of the system and the golf clubs or the affiliates, the GI&S system will send auto answers following the required action.

Sending information. This is for the purpose of having proper information on all the elements that conform to this GI&S system; golf clubs, golf courses and affiliates, any change or benefit obtained for the affiliates.

Report. Golf clubs, golf courses, affiliates and administrators of this system require information generated by the contained data in the databases of the GI&S system. Each one demands, depending on their level of interaction with the system, in the form that is agreeable to that, that is to say, printed screen or through a printed report.

The module of golf clubs is the subsystem that accesses the golf clubs, and is operated by each golf club. It is charged to carry out the management of his members to participate in this exchange system by means of the following:

Members. Normally, it is the member that has the first contact with GI&S and in the majority of the cases, it is the member of the golf club that has filled the preregistration form directly on the GI&S site, where this data is stored in the database corresponding to the golf club to which they belong, this data provided by the member at its preregistration. The golf club, when registering in the Exchanges system, has access to this information and has the possibility of validating and registering it to the Exchanges system if the member has asked for it. Stated in another manner, it is the golf club that will have to fill out this registry in order to register its members that have asked for registration, always observing the commitments and obligations established in the established contract of adhesion. In conclusion, all the golf clubs that register members to the Exchange system have only one way to participate in this system. From being registered “members” of the golf clubs, in GI&S, they are denominated as “affiliates.”

Tee Time. When the affiliate asks his golf club for use rights (specific dates) to deposit in the Exchanges system, that he would not play in his own golf club, and the authorized golf club assigns tee times (hour and minutes for the use of the golf course) to each one of the use rights authorized, these automatically will go to the database of use rights (like tee times) available in the Exchanges System. If the golf club is not authorized, the system will automatically send an email informing the affiliate of the refusal. The use rights to deposit will have the restriction that they must be effective 15 days minimum previous to their date of use. Similarly, use rights will have to indicate when it is a group request, informing whereupon other affiliates it wishes to form group. Each of the group members must submit their individual request of authorization of use rights with the same indication, since the golf club through the allocation of tee time forms the groups of players to participate in the exchange.

Modifications. When an affiliate has deposited use rights in the Exchanges system, but wishes to change the date, use rights can be modified by his golf club, as long as they have not already been taken in exchange by another affiliate of the system, and will be subject to the following restriction: the use rights to deposit must be effective 15 days minimum previous to their date of use.

Incapacitation of affiliates. This module is shared between the golf club and GI&S, since it can disqualify an affiliate, as long as there is a violation to the norms, rules or agreements of some of the aforementioned entities.

Unsubscribing. This module is shared between the golf club and GI&S, since it can unsubscribe an affiliate, as long as there is a provable violation to the norms, established rules or agreements.

Reports. The Exchanges system automatically generates operations information between affiliates and golf clubs, through informative reports, sent mostly by e-mail. Similarly, it generates daily reports for the affiliates of golf clubs that will play that day in their exchanged golf course, as well as of the affiliates of that golf club that do not have to play in the deposited dates.

Module of Affiliates. Once a golf club member is registered in the system, he becomes an affiliate of the Exchanges system GI&S, and the system grants access to him to this module through a password generated by the same affiliate, with which he has the right to participate in all the kindness and benefits of the Exchanges system, with the limitations and restrictions decided by its golf club and that the same agreed directly with GI&S.

Deposit of use right (Tee Time). Through this module, the affiliates ask their golf club for the authorization to deposit use rights in the Exchanges system that he would not use in play in his golf club, with the object of generating spaces to realize exchanges when he needs them. The tee time to deposit will have the restriction of an effective date 15 days minimum previous to their date of use. The previous restriction is only for deposit of tee time, it does not apply to tee times taken in exchange because the exchange can be done the same day that its golf club authorized his tee times. The system automatically will take in reciprocity tee times deposited dated more advisable in exchange.

Exchanges. Once authorized, tee times by the golf club or golf course are automatically registered in the GI&S system within the database of tee times available for exchange, so that any other affiliate (with tee times deposited previously and already available) can exchange them. Then, when the affiliate has access to this module of exchanges and can see or take so many tee times in exchange as those that he has deposited, when and where he wants, within the available options that the same system presents.

Allocation of use right and payment of quota of exchange. When an affiliate makes an exchange, that is to say, takes tee times from the database of exchanges available, he follows the following steps: a) make the selection from the database of existing exchanges; b) the system collects payment for the exchange quota, in the form that is suitable to the affiliate and GI&S; c) once this quota is paid, the system reserves the tee time with the chosen golf club and assigns it to the affiliate player; d) the Exchanges system sends an email of the confirmation or the realized exchanges to the affiliate, his golf club of origin and the chosen golf club.

Exchanges Reports. The affiliates have access to this module for making valid exchanges and in order that they are informed of exchange dates; however, the system itself alerts via email in advance of the date of each exchange.

Groups. In this module the affiliates that wish to form exchange groups ask their golf club for authorization, along with their authorization request for use rights. This module is operated by the golf clubs that allow groups in exchange. The golf club is to assign the same tee time to the system as the member asks, having its limits, and the modality that the same club offers in exchange. The member's affiliates that form the group will have to carry out the normal steps of exchange with GI&S, except the election of individual tee times, because the election will have to be by another group formed by the same amount of players, currently in the database of available exchanges.

Module of Services. The module of services has the purpose of providing the facilities and comforts that an affiliate requires for the practice of golf, and includes additional services that the visiting affiliate wishing to play demands from another golf course. It is in this module where the affiliates are informed of additional benefits, such as discounts in airlines, hotels, restaurants, rentals, golf equipment and accessories, memberships in golf clubs, etc.

Module of Information and Aid. The module of information and aid consists of the programs necessary to unfold and to give interested players the information that they require about the GI&S system, as well as for its correct handling. It also provides information of general interest concerning the world of golf, news, leagues, participating golf clubs, FAQs and contact information for the administrators of the GI&S system.

Mode of operation of the system. Described in the following paragraphs.

GI&S negotiates contracts with the golf clubs so that they accept the Exchanges system and provide services with the same quality to the affiliates of the Exchanges system.

The golf club already registered, will register in the Exchanges system its members that ask for it.

The member of a golf club registered to the Exchanges system becomes an affiliate of the system and will have access from an Internet-accessible computer to the benefits of the system, using his password that the same defines when registering. This means that he can deposit the use rights that he wants in the system, after approval of the golf club to which he belongs.

Once the use rights are approved, they go to a database which is available at an international level so that they can be taken in exchange by affiliates of the Exchanges system they have complied with all the above steps. The module has the possibility of integrating groups of players (2, 3, 4 players) as long as its golf club also accepts groups in exchange.

After depositing use rights, the Exchanges system allows the new affiliate access to the database to take tee times that are available and amenable to their interests. The affiliate will, at most, take so many use rights as the deposited ones, there being no objection if he takes less than the deposited ones.

Once the use rights are selected and taken, the affiliate will have to pay the system the quota of exchange stipulated by each use right taken, and the Exchanges System will automatically send by email the exchange confirmation to both golf clubs (golf club of origin and chosen golf club) and to the same member that selected it.

In a preferred modality of the invention, the online exchanges system of golf course use rights consists of an information system based on applications on an Internet network and its computer resources that allow the interaction of member players of different golf clubs which have previously signed an adhesion contract to this system to realize exchanges of use rights among affiliates and different golf clubs to which they belong.

This system includes: an administration module of information related to affiliates and golf clubs, use rights of affiliates proposed for exchange, taken use rights, payment of quotas by exchange of use rights and characteristics of the golf clubs and/or restrictive conditions established by the same for the exchange of such use rights among affiliates to the system; a module of golf clubs operated by the golf clubs or golf courses, by means of which, these golf clubs can manage the module of system management to sign up or unsubscribe their members to the exchanges system, deposit authorized use rights for exchange of their members and to define requirements and/or conditions that will have to be fulfilled on the part of the members of other golf courses or golf clubs affiliates for the due authorization of the exchange of use rights of their golf courses; and a module of affiliates which the affiliate can access via the Internet with a password to ask for his golf club's authorization of use rights to deposit in the exchanges system, and to verify the availability of use rights supplied by affiliates of other golf clubs and to choose those that are preferred by him.

Also, the method of online exchanges online for golf course use rights is distinguished by the following stages: to form contracts with golf clubs whose members are interested in the exchange of their use rights with members of other golf clubs, so that they offer the same services to their affiliate members to the exchanges system; to register (sign up) or to affiliate in the exchanges system the members interested through their golf club; to allow Internet access to the exchanges system for the new affiliates so that they can deposit in the exchanges system previously authorized use rights by the golf club to which they belong; to allow the affiliate that has deposited his tee times access to the databases that contain information on tee times available so that he chooses those that he wishes to take in exchange; to collect the exchange quota stipulated by each use right taken in exchange; and automatically to send by email or by any other means (telephone, facsimile, postal mail, etc.) the confirmation of the realized exchange to the golf club of origin, the chosen golf club and the same affiliate.

Although this invention has been described in the context of the specific modalities preferred, for the specialists in the matter it will be evident that the reach of the present invention extends beyond the modalities specifically described to other alternating modalities and/or uses of the invention that are obvious and derivatives of the same.

In addition, although the invention has been described in detail, some other modifications or changes, which are within the reach of the present invention, will be clearly obvious for specialists in this matter, in particular in the description above. Therefore, it is anticipated that several combinations of the specific characteristics and aspects of the described modalities can be realized that would fall unquestionably within the reach of the invention. Taking into account the previous statement, it will be understood that several characteristics and aspects of the described modalities can be combined with others or be replaced by others to form alternating ways of accomplishment of the invention before described. This way, the reach of the protection of the described system and method will not have to be limited by the particular modalities that have been described and illustrated here before, but this reach will have to be defined by a reasonable reading of the following claims.

1. Exchanges system via Internet of use rights for golf courses, that consists of computer programs comprising an information system based on applications in network by Internet means and its computing resources that allow the interaction of member players of different golf clubs which have previously signed an adhesion contract to this system, to realize exchanges of use rights among the affiliates the system and the different golf clubs to which they belong, this system includes:
a site on the Internet (website), connected to a main computer or server;
a module of information administration related to affiliates and golf clubs or golf courses, use rights of affiliates proposed for exchange, taken use rights, payment of quotas by exchange and characteristics of the golf clubs and/or restrictive conditions established by the same for the exchange of such use rights among affiliates to the system;
a module of golf clubs operated by golf clubs or golf courses, which these golf clubs can manage through the Internet; sign up or unsubscribe its members to the exchanges system, to authorize or to reject use rights of their members and to define requirements and/or conditions that will have to be fulfilled on the part of the members of other golf courses or golf clubs affiliates for the due authorization of the exchange of use rights for their golf courses; and
a module of affiliates which a member affiliate may access by Internet with a password to ask for golf club authorization of use rights to deposit in the exchanges system, and to verify the availability of tee times supplied by affiliates of other golf clubs, and to have the capacity of election of dates and golf courses to select.

2. The system of claim 1, comprised in a Website on the Internet includes all the information regarding the exchanges system, leagues of interest and form to contact the system administrators.

3. The system of claim 1, in which the Website on the Internet interacts with the modules of the system for the exchange of tee times.

4. The system of claim 1, in which the deposited use rights for exchange cannot be used in their golf club of origin by the same offering affiliate in order that spaces are generated in the golf clubs to realize exchanges.

5. The system of claim 1, in which the system automatically informs the affiliates about any refusal for use rights deposited.

6. The system of claim 1, in which the use rights deposited must be effective a period of time predetermined previous to their date of use.

7. The system of claim 1, in which once use rights of the affiliate are deposited in the exchanges system, this affiliate will have access to the information of use rights available deposited by others for exchange effects (in agreement with the restrictions established by the participant golf clubs).

8. The system of claim 1, in which the affiliate will be able to exchange so many use rights available as those that the affiliate has deposited.

9. The system of claim 1, in which the exchange of use rights are concrete when the affiliate makes the payment of the quota stipulated by each use rights taken and then the system only reserves the use rights of the chosen golf club and assigns the player affiliate to the use rights.

10. The system of the claim the 1, in which this system confirms to the golf club of origin of the affiliate, to the chosen golf clubs and to the affiliate the realized exchanges.

11. The system of claim 1, that generates automatically and ahead of time reports to the affiliates on its dates of exchange.

12. The system of claim 1, which allows in addition that affiliates interested in forming exchange groups can ask their golf club, which processes the authorization of corresponding use rights in the exchanges system.

13. The system of claim 1, which also includes a module that provides services to affiliated facilities and benefits of additional discounts on certain services associated with the visit to another golf course or golf club, such as air transportation, lodging, restaurants, rent cars, golf equipment, accessories, among others.

14. The system of claim 1, which includes an administrator of emails, routing automatically the messages depending on its content for its suitable attention.

15. The system of claim 1, which generates automatic answers to incoming messages of emails or information generated by the interaction of the system with the golf clubs or affiliates.

16. The system of claim 1, which includes a system report to generate reports for the system, golf clubs and affiliates about the information that is required for each element of the system.

17. The system of claim 1, in which the data contributed by the affiliates and golf clubs are handled confidentially.

18. A method for exchanges via the Internet of use rights for golf courses, this method consists of the following stages:
to form contracts with golf clubs whose members are interested in the exchange of their use rights with members of other golf clubs, so that they offer the same services to its members as to member's affiliates to the exchanges system;
to register or to affiliate in the exchanges system the members interested through their already registered golf club;
to allow access via the Internet to the exchanges system to the registered affiliates so that they may deposit in the exchanges system use rights previously authorized by the golf club to which they belong;
to allow control of tee times deposited; those deposited on weekdays (Monday-Friday) can only be exchanged for another weekday, tee time deposited n weekends (Saturday-Sunday) may be exchanged preferably for weekends or weekdays;
to allow the affiliate that has deposited use rights access to the data bases which contain information on tee times available, so that the affiliate chooses those that he wishes to take in exchange;
to collect the quota of exchange stipulated by each tee time taken in exchange; and
to automatically send confirmation, via the Internet, of the realized exchange to the golf club of origin, the chosen golf club and the same affiliate.

19. The method of claim 18, in which the access to the exchanges system is by means of customized password.

20. The method of claim 18, in which the affiliate will be able to take so many use rights as those that it has deposited.

21. The method of claim 18, in which the deposited use rights are available in an international database for exchange for all the affiliates to the system.

22. The method of claim 18, in which the affiliates can deposit use rights for exchange in groups between golf clubs that allow it.

23. The method of claim 18, in which the exchange of tee times are concrete when the affiliate makes the payment of the quota stipulated by each tee time taken and then the system only reserves with the chosen golf club the tee time chosen and it assigns to the player affiliate.

24. The method of claim 18, in which reports to the affiliates are generated automatically and ahead of time on their dates of exchange.

25. The method of claim 18, in which each golf club can choose its classification of golf club (private, semi-private, resort, military and public), and similarly to select which class or classes of golf clubs it would like to make exchanges with.

26. The method of claim 18, in which each golf club can announce its rules and facilities in the use of its facilities for knowledge of the affiliates before they carry out any exchange.

27. The method of claim 18, in which the affiliates can carry out changes, previous approval of its golf club, of the deposited use rights that not yet have been taken in exchange by other affiliates.

28. The method of claim 18, in which the system or the golf club can disqualify an affiliate if the affiliate violates some norm or regulation of the signed agreements.

29. The method of claim 18, in which the golf clubs, golf courses or affiliates are unsubscribed to the exchanges system, by own will or violation to the agreements.

30. The method of claim 18, in which the interaction with the participant members in the exchange of use rights can be through other effective mass media as they are telephony, postal mail, traditional facsimile, etc.
